(19) United States
(12) Patent Application Publication
(10) Pub. No.: US 2023/0177621 A1
(43) Pub. Date: Jun. 8, 2023

(54) GENERATION AND DELIVERY OF INTEREST-BASED COMMUNICATIONS

(71) Applicant: Meta Platforms, Inc., Menlo Park, CA (US)

(72) Inventors: Zigang Xiao, Sunnyvale, CA (US); Yanyu Zhang, Newark, CA (US); Prasoon Mishra, San Francisco, CA (US); Kaitlyn M. Smith, Maplewood, NJ (US); Alex Tsai, Seattle, WA (US); Jordan Springstroh, Austin, TX (US)

(73) Assignee: Meta Platforms, Inc., Menlo Park, CA (US)

(21) Appl. No.: 17/893,896

(22) Filed: Aug. 23, 2022

Related U.S. Application Data
(60) Provisional application No. 63/264,076, filed on Nov. 15, 2021.
(60) Provisional application No. 63/322,019, filed on Mar. 21, 2022.

(51) Int. Cl. G06Q 50/00; G06Q 30/02

(52) U.S. Cl. CPC G06Q 50/01; G06Q 30/0201

(57) ABSTRACT

According to examples, a system for generating and delivering enhanced content utilizing remote rendering and data streaming is described. The system may include a processor and a memory storing instructions. The processor, when executing the instructions, may cause the system to generate one or more interests associated with a user, generate a taxonomy based on the one or more interests associated with the user and associate the one or more interests associated with the user. The processor, when executing the instructions, may then determine a relationship between a first user and a second user utilizing the one or more interests associated with the user; determine an arrangement of a plurality of users in relation to the user and a plurality of other users; and generate an engagement item in association with the user

### PRIORITY

This patent application claims priority to U.S. Provisional Pat. Application No. 63/264,076, entitled “Generation and Delivery of Interest-based Communications,” filed on Nov. 15, 2021, and U.S. Provisional Pat. Application No. 63/322,019, entitled “Generation and Delivery of Related User Interactions using Artificial Intelligence (AI) based Techniques,” filed on Mar. 21, 2022.

### TECHNICAL FIELD

This patent application relates generally to generation and delivery of content, and more specifically, to systems and methods for generation of a shared interest between a first user and a second user and utilization of the generated shared interest to facilitate communication between the first user and the second user, and further for systems and methods for utilization of artificial intelligence (AI) techniques to generate and deliver related user interactions based on existing user interactions.

### BACKGROUND

With recent advances in technology, prevalence and proliferation of content creation and delivery has increased greatly in recent years. Content providers are continuously looking for ways to deliver more appealing content.

One way to deliver content of interest may be to deliver content based on a user’s interests. In some instances, another way to deliver content that may likely be of interest to a user may be to facilitate a communication based on an interest that may be shared with another user.

However, it should be appreciated that various issues may arise when endeavoring to utilize a user’s interest(s) or utilize a shared interest between a first user and a second user. In some instances, fragmentation and nomenclature issues may make it difficult to utilize a user’s interest(s), or to utilize a particular shared interest between the first user and the second user. As a result, this may often lead to less appealing content, and to less interest and less engagement from users.

One of the most appealing and convenient forms of content is text content. Examples include user groups and user pages on content platforms. Users may particularly favor such content as it may enable them to discuss a wide variety of subject matter(s) with like-minded (i.e., similarly interested) users.

In some instances, a user participating in a particular user group or a particular user page may wish to generate a related user group or user page. For example, in one such instance, a member of a user group on a content platform entitled “Let’s all be politicians today” may wish to create a related group entitled “Let’s all be parents today.” However, it should be appreciated that, in some instances, recruiting users to the (new) related group may be inconvenient, as it may require more time and effort than a user may wish to expend.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIGS. 1A-1E illustrate various aspects of a system environment, including a system, that may be implemented to generate shared interests between a first user and a second user and utilize the generated shared interests to facilitate communication between the first user and the second user, according to an example.

FIG. 2 illustrates a block diagram of a computer system to generate shared interests between a first user and a second user and utilize the generated shared interests to facilitate communication between the first user and the second user, according to an example.

FIG. 3 illustrates a flowchart of a method for generating shared interests between a first user and a second user and utilizing the generated shared interests to facilitate communication between the first user and the second user, according to an example.

FIG. 4 illustrates a diagram of an implementation structure for a neural network (NN) implementing deep learning to generate and deliver related user interactions based on existing user interactions, according to an example.

FIGS. 5A-5D illustrate various aspects of a system environment, including a system, that may be implemented to use artificial intelligence (AI) techniques to generate and deliver related user interactions based on existing user interactions, according to an example.

FIG. 6 illustrates a method for using artificial intelligence (AI) techniques to generate and deliver related user interactions based on existing user interactions, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Advances in content management and media distribution are causing users to engage with content on or from a variety of content platforms. As used herein, a “user” may include any user of a computing device or digital content delivery mechanism who receives or interacts with delivered content items, which may be visual, non-visual, or a combination thereof. Examples of a user may include, but are not limited to, an individual, a company, a group, an organization and the like. Also, as used herein, “content”, “digital content”, “digital content item” and “content item” may refer to any digital data (e.g., a data file). Examples include, but are not limited to, digital images, digital video files, digital audio files, and/or streaming content. Additionally, the terms “content”, “digital content item,” “content item,” and “digital item” may refer interchangeably to themselves or to portions thereof.

With the proliferation of different types of digital content delivery mechanisms (e.g., mobile phone, portable computing devices, tablet devices, etc.), it has become crucial that content providers engage users with content of interest and deliver the content in the most convenient manner possible. As a result, content providers are continuously looking for ways to efficiently deliver more appealing content.

In some examples, one way to deliver content of interest may be to deliver content based on a user’s interests or activity. However, it should be appreciated that various issues may arise when endeavoring to utilize a user’s interest(s). In some instances, a user may be reluctant or unwilling to provide their interests (e.g., when provided with an “opt-out” option). Moreover, as such self-reporting (i.e., submission) of personal interest-related information may be tedious or difficult.

In some instances, another way to deliver content likely be of interest may be to provide a content item based on an interest shared with another user. As used herein, a first user and a second user may have a “shared interest” if they may share (among other things) an interest that may be common (i.e., identical) or an interest that may be similar.

In some examples, a shared interest may be based on a first user and a second user having a commonality. In some instances, if a first user and a second user may subscribe to a same destination location (e.g., website, podcast, social media account, etc.), a defining aspect of the destination location may be regarded to be a shared interest for the first user and the second user. In other instances, a first user and a second user may be a member of a same (virtual) group, wherein whatever aspect(s) may be a defining aspect of the group may be a shared interest for the first user and the second user. However, in some examples, deriving interests based on commonalities between a first user and a second user may not necessarily provide a basis for a shared interest, as each user may be associated with the commonality (e.g., a website) for varied reasons.

It should also be appreciated that various issues may arise when endeavoring to utilize a shared interest between a first user and a second user. First, “fragmentation” may make it difficult to determine a particular shared interest between a first user and a second user. Indeed, in some examples, a broader (i.e., parent) interest may be associated with and may “birth” numerous, more-narrower (i.e., child) interests. As a result, it may be difficult to match up numerous, different interests that may, in fact, be similar.

Also, in some examples, it may be difficult to correlate a first user’s (first) interest to a second user’s (second) interest. So, where a first user may subscribe to a first social media page related to a particular pop music star and a second user may subscribe to a second social media page related to a film awards show, the first user and the second user may both share an interest in celebrity culture. However, it may be difficult to determine this shared interest since the two interests (i.e., pop music star, film awards show) may appear too unrelated. In some instances, this difficulty associated with determining a shared interest may be referred to as an issue of “correlation”.

In addition, in some examples, it may be difficult to associate a first user’s interest to a second user’s interest due to issues in notation or nomenclature. In particular, in some examples, a manner in which a first interest and a second interest may be designated or described may make it difficult to see that they may be similar. So, although a member of “Menlo Park Ballers” group and a member of “Palo Alto Ballers” group may share an interest in basketball, a literal analysis of group names may lead to a determination that no shared interest may exist.

Systems and methods are directed to generating shared interests between a first user and a second user and utilizing the generated shared interests to facilitate communication between the first user and the second user. In particular, in some examples, the systems may analyze various information, determine one or more shared interests between a first user (i.e., the first user) and a second user (i.e., the second user) and may facilitate a communication between the first user and the second user based on the determined shared interest.

In some examples, to generate shared interests between a first user and a second user and to utilize the generated shared interests to facilitate a communication between the first user and the second user, the systems and methods may generate one or more interests that may be associated with user activity. To generate one or more interests, the systems and methods may generate a taxonomy based on a plurality of interests that may include “parent” and “child” relationships. In some examples, to utilize one or more interests associated with user activity, the systems and methods may generate an interest score associated with the one or more interests and the user. In some examples, the one or more interests associated with user activity may be utilized to generate a user interest profile (UIP) that may describe one or more interests associated with the user.

In some examples, the systems and methods may utilize one or more interests to determine a relationship between a first user and a second user. In some examples, a relationship between the first user and the second user may be based on “common” interests. Also, in some examples, a relationship between the first user and the second user may be based on “similarity”.

In some examples, any information associated with the user may be gathered and utilized according to various policies. For example, in particular embodiments, privacy settings may allow users to review and control, via opt in or opt out selections, as appropriate, how their data may be collected, used, stored, shared, or deleted by the systems and methods or by other users (e.g., other users or third-party systems), and for a particular purpose. The systems and methods may present users with an interface indicating what data is being collected, used, stored, or shared by the systems and methods described (or other users), and for what purpose. Furthermore, the systems and methods may present users with an interface indicating how such data may be collected, used, stored, or shared by particular processes of the systems and methods or other processes (e.g., internal research, advertising algorithms, machine-learning algorithms). In some examples, a user may have to provide prior authorization before the systems and methods may collect, use, store, share, or delete data associated with the user for any purpose.

Moreover, in particular embodiments, privacy policies may limit the types of data that may be collected, used, or shared by particular processes of the systems and methods for a particular purpose (as described further below). In some examples, the systems and methods may present users with an interface indicating the particular purpose for which data is being collected, used, or shared. In some examples, the privacy policies may ensure that only necessary and relevant data may be collected, used, or shared for the particular purpose, and may prevent such data from being collected, used, or shared for unauthorized purposes.

Also, in some examples, the collection, usage, storage, and sharing of any data may be subject to data minimization policies, which may limit how such data that may be collected, used, stored, or shared by the systems and methods, other users (e.g., other users or third-party systems), or particular processes (e.g., internal research, advertising algorithms, machine-learning algorithms) for a particular purpose. In some examples, the data minimization policies may ensure that only relevant and necessary data may be accessed by such users or processes for such purposes.

In addition, it should be appreciated that in some examples, the deletion of any data may be subject to data retention policies, which may limit the duration such data that may be user or stored by the systems and methods (or by other users), or by particular processes (e.g., internal research, advertising algorithms, machine-learning algorithms) for a particular purpose before being automatically deleted, de-identified, or otherwise made inaccessible. In some examples, the data retention policies may ensure that data may be accessed by such users or processes only for the duration it is relevant and necessary for such users or processes for the particular purpose. In particular examples, privacy settings may allow users to review any of their data stored by the systems and methods or other users (e.g., third-party systems) for any purpose, and delete such data when requested by the user.

In some examples, the systems and methods may determine an arrangement of a plurality of users in relation to a first user. In some examples, to determine the arrangement of the plurality of users, the systems and methods may utilize determine a plurality of interest scores that may be determined with respect to a first user and a plurality of (other) users to generate a similarity queue of users. As will be discussed further below, the arrangement of the plurality of users based on interests may be utilized to generate engagement among users in association with a variety of activities, such as dating, volunteer work, social causes, etc.

In some examples, the systems and methods may generate an engagement item associated with a first user a second user. In particular, in some examples, the systems and methods may generate an engagement item between the first user and the second user based on a shared interest.

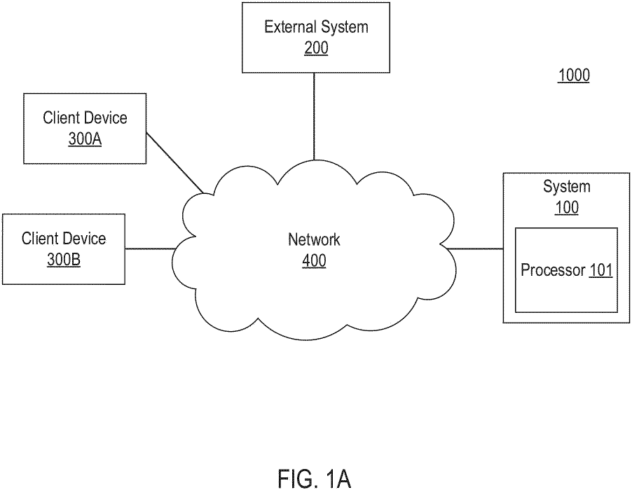

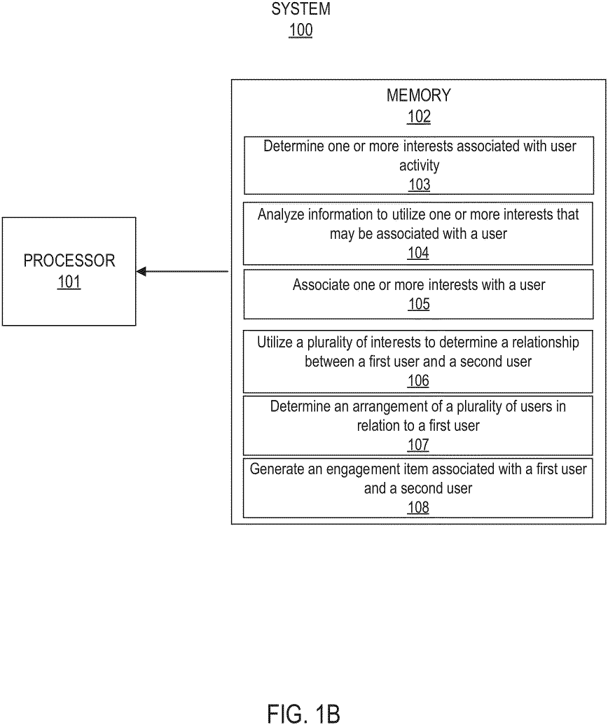

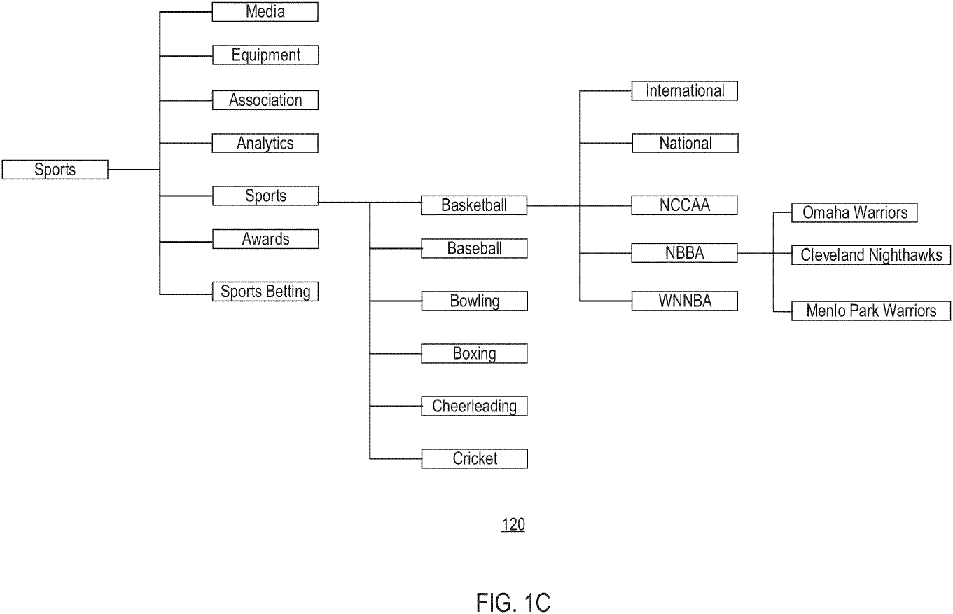

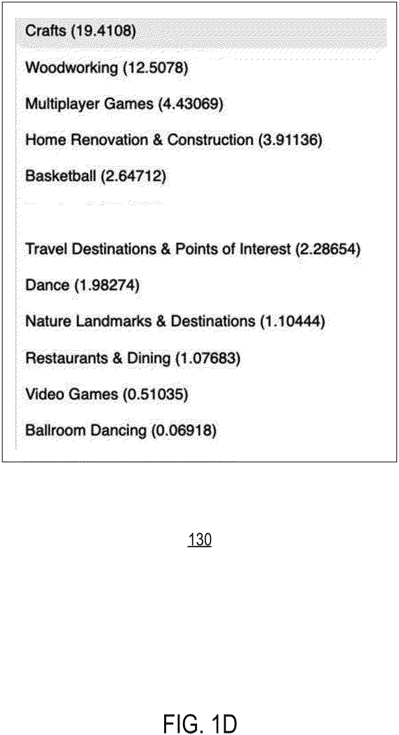

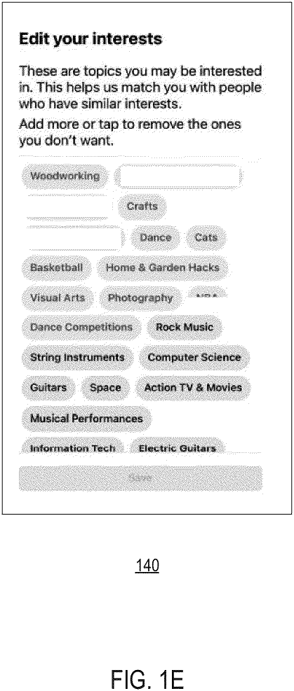

Reference is now made to FIGS. 1A-1B. FIG. 1A illustrates a block diagram of a system environment, including a system, that may be implemented to generate shared interests between a first user and a second user and utilize the generated shared interests to facilitate communication between the first user and the second user, according to an example. FIG. 1B illustrates a block diagram of the system that may be implemented to generate shared interests between a first user and a second user and utilize the generated shared interests to facilitate communication between the first user and the second user, according to an example.

As will be described in the examples below, one or more of system 100, external system 200, user devices 300A-300B and system environment 1000 shown in FIGS. 1A-1B may be operated by a service provider to generate shared interests between a first user and a second user and utilize the generated shared interests to facilitate communication between the first user and the second user. It should be appreciated that one or more of the system 100, the external system 200, the user devices 300A-300B and the system environment 1000 depicted in FIGS. 1A-1B may be provided as examples. Thus, one or more of the system 100, the external system 200 the user devices 300A-300B and the system environment 1000 may or may not include additional features and some of the features described herein may be removed and/or modified without departing from the scopes of the system 100, the external system 200, the user devices 300A-300B and the system environment 1000 outlined herein. Moreover, in some examples, the system 100, the external system 200, and/or the user devices 300A-300B may be or associated with a social networking system, a content sharing network, an advertisement system, an online system, and/or any other system that facilitates any variety of digital content in personal, social, commercial, financial, and/or enterprise environments.

While the servers, systems, subsystems, and/or other computing devices shown in FIGS. 1A-1B may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 100, the external system 200, the user devices 300A-300B or the system environment 1000.

It should also be appreciated that the systems and methods described herein may be particularly suited for digital content, but are also applicable to a host of other distributed content or media. These may include, for example, content or media associated with data management platforms, search or recommendation engines, social media, and/or data communications involving communication of potentially personal, private, or sensitive data or information. These and other benefits will be apparent in the descriptions provided herein.

In some examples, the external system 200 may include any number of servers, hosts, systems, and/or databases that store data to be accessed by the system 100, the user devices 300A-300B, and/or other network elements (not shown) in the system environment 1000. In addition, in some examples, the servers, hosts, systems, and/or databases of the external system 200 may include one or more storage mediums storing any data. In some examples, and as will be discussed further below, the external system 200 may be utilized to store any information that may relate to generation and delivery of content (e.g., user information, etc.).

In some examples, and as will be described in further detail below, the user devices 300A-300B may be utilized to, among other things, generate shared interests between a first user and a second user and utilize the generated shared interests to facilitate communication between the first user and the second user. In some examples, the user devices 300A-300B may be electronic or computing devices configured to transmit and/or receive data. In this regard, each of the user devices 300A-300B may be any device having computer functionality, such as a television, a radio, a smartphone, a tablet, a laptop, a watch, a desktop, a server, or other computing or entertainment device or appliance. In some examples, the user devices 300A-300B may be mobile devices that are communicatively coupled to the network 400 and enabled to interact with various network elements over the network 400. In some examples, the user devices 300A-300B may execute an application allowing a user of the user devices 300A-300B to interact with various network elements on the network 400. Additionally, the user devices 300A-300B may execute a browser or application to enable interaction between the user devices 300A-300B and the system 100 via the network 400. In some examples, and as will described further below, a client may utilize the user devices 300A-300B to access a browser and/or an application interface for generation of shared interests between a first user and a second user and utilization of the generated shared interests to facilitate communication between the first user and the second user. Moreover, in some examples and as will also be discussed further below, the user devices 300A-300B may be utilized by a user to receive a communication based on a shared interest between the first user and the second user, wherein information relating to the user may be stored and transmitted by the user devices 300A to other devices, such as the external system 200.

The system environment 1000 may also include the network 400. In operation, one or more of the system 100, the external system 200 and the user devices 300A-300B may communicate with one or more of the other devices via the network 400. The network 400 may be a local area network (LAN), a wide area network (WAN), the Internet, a cellular network, a cable network, a satellite network, or other network that facilitates communication between, the system 100, the external system 200, the user devices 300A-300B and/or any other system, component, or device connected to the network 400. The network 400 may further include one, or any number, of the exemplary types of networks mentioned above operating as a stand-alone network or in cooperation with each other. For example, the network 400 may utilize one or more protocols of one or more clients or servers to which they are communicatively coupled. The network 400 may facilitate transmission of data according to a transmission protocol of any of the devices and/or systems in the network 400. Although the network 400 is depicted as a single network in the system environment 1000 of FIG. 1A, it should be appreciated that, in some examples, the network 400 may include a plurality of interconnected networks as well.

It should be appreciated that in some examples, and as will be discussed further below, the system 100 may be configured to utilize artificial intelligence (AI) based techniques and mechanisms to generate shared interests between a first user and a second user and utilize the generated shared interests to facilitate communication between the first user and the second user. Details of the system 100 and its operation within the system environment 1000 will be described in more detail below.

As shown in FIGS. 1A-1B, the system 100 may include processor 101, a graphics processor unit (GPU) 101a, and the memory 102. In some examples, the processor 101 may be configured to execute the machine-readable instructions stored in the memory 102. It should be appreciated that the processor 101 may be a semiconductor-based microprocessor, a central processing unit (CPU), an application specific integrated circuit (ASIC), a field-programmable gate array (FPGA), and/or other suitable hardware device.

In some examples, the memory 102 may have stored thereon machine-readable instructions (which may also be termed computer-readable instructions) that the processor 101 may execute. The memory 102 may be an electronic, magnetic, optical, or other physical storage device that contains or stores executable instructions. The memory 102 may be, for example, Random Access memory (RAM), an Electrically Erasable Programmable Read-Only Memory (EEPROM), a storage device, an optical disc, or the like. The memory 102, which may also be referred to as a computer-readable storage medium, may be a non-transitory machine-readable storage medium, where the term “non-transitory” does not encompass transitory propagating signals. It should be appreciated that the memory 102 depicted in FIGS. 1A-1B may be provided as an example. Thus, the memory 102 may or may not include additional features, and some of the features described herein may be removed and/or modified without departing from the scope of the memory 102 outlined herein.

It should be appreciated that, and as described further below, the processing performed via the instructions on the memory 102 may or may not be performed, in part or in total, with the aid of other information and data, such as information and data provided by the external system 200 and/or the user devices 300A-300B. Moreover, and as described further below, it should be appreciated that the processing performed via the instructions on the memory 102 may or may not be performed, in part or in total, with the aid of or in addition to processing provided by other devices, including for example, the external system 200 and/or the user devices 300A-300B.

In some examples, the memory 102 may store instructions, which when executed by the processor 101, may cause the processor to: utilize one or more interests associated with user activity; analyze information to utilize one or more interests that may be associated with a user; and associate one or more interests with a user. In addition, the instructions, when executed by the processor 101, may further cause the processor to utilize a plurality of interests to determine a relationship between a first user and a second user; determine an arrangement of a plurality of users in relation to a first user; and generate an engagement item associated with a first user a second user.

In some examples, and as discussed further below, the instructions 103-108 on the memory 102 may be executed alone or in combination by the processor 101 to generate shared interests between a first user and a second user and utilize the generated shared interests to facilitate communication between the first user and the second user. In some examples, the instructions 103-108 may be implemented in association with a content platform configured to provide content for users, while in other examples, the instructions 103-108 may be implemented as part of a stand-alone application.

Additionally, although not depicted, it should be appreciated that to generate shared interests between a first user and a second user and utilize the generated shared interests to facilitate communication between the first user and the second user, instructions103-108 may be configured to utilize various artificial intelligence (AI) based machine learning (ML) tools. For instance, these AI-based machine learning (ML) tools may be used to generate models that may include a neural network, a generative adversarial network (GAN), a tree-based model, a Bayesian network, a support vector, clustering, a kernel method, a spline, a knowledge graph, or an ensemble of one or more of these and other techniques. It should also be appreciated that the system 100 may provide other types of machine learning (ML) approaches, such as reinforcement learning, feature learning, anomaly detection, etc.

In some examples, the instructions 103 may generate a taxonomy including a plurality of categories. As used herein, a “taxonomy” may include any classification or categorization scheme, hierarchy or structure. In some examples, a taxonomy generated via the instructions 103 may exhibit a “tree-structure” wherein a plurality of categories may be arranged based on an ascending (or descending) level of particularity. So, in these examples, a general (i.e., broader) category may be designated a “parent” of a more particular (i.e., narrower) category that may be a “child”. In one example where a tree-based structure may include a “parent” category of “Federal Basketball Association”, the tree-based structure may also include a “child” category of “Omaha Warriors” and “Cleveland Nighthawks” (i.e., teams in the Federal Basketball Association).

It should be appreciated that the taxonomy generated via the instructions 103 may be extensible, and may be configured to incorporate newly and continuously discovered or created categories. Indeed, in some examples, the instructions 103 may initially generate a taxonomy, and may continually add to the taxonomy to accommodate new and modified categories. An example of a taxonomy 120 including a plurality of arranged interests is illustrated in FIG. 1C.

In some examples, the instructions 103 may generate one or more interests that may be associated with user activity. As used herein, an “interest” that may be associated with user activity may include any categorization, classification, aspect or description that may be associated with user. Examples of such “user activity” may be any content that may be generated in association with a user and that may be obtained from any content source, such as a social media platform. Examples of interests may include (but are not limited to) hobbies, entities (e.g., companies, sports teams), individuals, products, services, topics, social “causes”, values, groups, and activities. An example of a plurality of interests 130 that may be associated with user activity is illustrated in FIG. 1D.

So, in some examples, the instructions 103 may generate the taxonomy prior to determining one or more interests (which are determined based on user activity). Furthermore, for each interest, a descriptive word may be associated with the interest to describe the interest. In these examples, a word describing an interest may be utilized in association with a taxonomy to describe an associated user. It should be appreciated that a taxonomy may generated prior to analyzing user activity to utilize interests, and may then be updated and modified according to analysis of user activity.

In some examples, to generate one or more interests that may be associated with user activity, the instructions 103 may determine a relationship between a first interest and a second interest. As used herein, a “relationship” may include any relation, interaction, commonality or other connection that may be a basis for associating a first interest with a second interest.

In some examples, the relationship between the first interest and the second interest may be based on a degree of particularity. For example, where the instructions 103 may determine that a first interest that may be associated with a user may be “basketball”, the instructions 103 may determine that a relationship with another interest such as “Federal Basketball Association” or “FBA” that may be based on particularity, (i.e., an interest in the “FBA” may be a more particular form of interest in “Basketball”).

In some examples, and as discussed further below, the instructions 104 may analyze information to utilize one or more interests that may be associated with a user. As a user’s interests may be numerous and varied, the information analyzed to utilize the one or more interests may be numerous and varied as well. In addition, in some examples, as described above, the instructions 104 may enable minimization of data collection and retention policies and may enable purpose-limited data collection as well.

In some examples, the information analyzed via the instructions 104 may potentially originate from any source. Examples include user answers submitted by the user in user surveys, user-submitted descriptions in user associated content (e.g., profile page information submitted by the user), etc.

In some examples, an opt-in interface provided by the instructions 104 may communicate to the user that the system may be requesting to collect the user’s and allow the user to opt in to the data collection or refuse to allow the system to collect transaction data. Upon receiving an affirmative consent from the user, the instructions 104 may, for example, utilize the provided information to determine one or more interests associated with the user.

In some examples, the information analyzed by the instructions 104 may be based on an aspect of an item (e.g., a content item) that a user may engage. So, for example, in an instance involving a content platform (e.g., a social media platform) with content items that a user may engage (e.g., select, view, listen, etc.), the instructions 104 may analyze aspects like title, descriptions and tags associated with the engaged content items to utilize an interest of a user. It should be appreciated that a listing of aspects that may be associated with a content item and that may be analyzed may be numerous and extensible, and may be configured to incorporate newly and continuously discovered or created aspects.

In some examples, the information analyzed by the instructions 104 may be based on actions taken by a user. That is, in some examples, when browsing on a content platform, a user may navigate particular destinations or provide particular interactions. These navigations and interactions may “signal” a particular interest from a user.

So, for example, if a user may participate in a content platform (e.g., a social media platform), the user may select one or more particular content items that may be (generally) associated with a particular category, or may “like” or “subscribe” to particular content item. In some examples, the instructions 104 may analyze aspects of the selected content items to associate an interest to the user. It should be appreciated that a listing of aspects that may be associated with actions taken by a user and that may be analyzed may be numerous and extensible, and may be configured to incorporate newly and continuously discovered or created aspects.

In some examples, to utilize one or more interests of a user, the instructions 104 may generate an interest score associated with the interest and the user. As used herein, a “score” may include any indication that may describe a degree or extent of an interest for a user.

Moreover, in some examples, the instructions 104 may generate a ranking of interests associated with a user. In particular, the instructions 104 may utilize a plurality of scores associated with a plurality of interests, and may arrange the plurality of interest scores in a ranking (e.g., from highest to lowest).

In some examples, the instructions 105 may associate one or more interests to a user. Moreover, in some examples, the one or more interests associated with a user may be utilized to generate a user interest profile (UIP). As used herein, a “user interest profile” may include any profile or characterization of a user that may be generated in association with an interest.

So, in some examples, a user interest profile (UIP) may describe one or more interests that may be utilized (e.g., via the instructions 104) and associated (e.g., via the instructions 105) with a user. In one example, the instructions 105 may generate a user interest profile (UIP) of the user may include between ten (10) and twenty (20) of the (e.g., highest-ranked) interests that may be associated with the user.

In some examples, to associate one or more interests with a user, the instructions 105 may enable a user to provide an interest. So, in some examples, the instructions 105 may be present (e.g., via a selectable user interface) a plurality of interests to a user that the user may select from. In one example, the plurality of selectable interests may be based on aspects associated with the user, while in another example, the plurality of selectable interests may be based on aspects unassociated with the user (e.g., a selected number of interests based on one or more other users). An example of a user interface element 140 to enable a user to select from among a plurality of interests is illustrated in FIG. 1E.

In addition, in some examples, the instructions 105 may enable a user to confirm an interest (e.g., that may be presented via a selectable user interface). So, in one such example, a user may be asked to confirm (or deny) an interest that may be presented. In this and other examples, the instructions 105 may provide an “opt-in” or “unlock” mechanism (e.g., via a check-box) may be provided as well.

Also, in some examples, the instructions 105 may enable a user to search for interest. Moreover, in some examples, upon receiving a returned list of interests, the instructions 105 may enable a user to select interests as well.

It should be appreciated that, in some examples, the instructions 104 and/or the instructions 105 may continuously analyze information associated with a user, utilize interests associated with the user and adjust and modify (i.e., update) a user interest profile (UIP) associated with the user. So, in some examples, the instructions 104 and the instructions 105 may continuously update a user interest profile (UIP) associated with a user.

It should further be appreciated that a user interest profile (UIP) generated via the instructions 105 may be utilized in a variety of contexts. For example, and as discussed further below, the user interest profile (UIP) generated via the instructions 105 may be utilized to determine an association between a first user and second user. So, in some examples, a determined association between the first user and the second user may be utilized to suggest or facilitate “dating” connections and/or communications. In other examples, the determined association between the first user and the second user may be utilized to suggest or facilitate (among other things) causes, hobbies, and activities that may relate to one or more of the first user and the second user.

In some examples, the instructions 106 may utilize a plurality of interests to determine a relationship between a first user and a second user. For example, in some instances, the instructions 106 may utilize one or more of one or more interests associated with a first user (e.g., as determined via the instructions 104), one or more interests associated with a second user (e.g., as determined via the instructions 104), and one or more relationships between a plurality of interests (e.g., a taxonomy generated by the instructions 103) to determine a relationship between a first user and a second user. Also, to determine a relationship between a first user and a second user, the instructions 106 may locate (e.g., overlay) one or more interests of the first user and the one or more interests of the second user with respect to the one or more relationships between a plurality of interests (e.g., the taxonomy generated by the instructions 103).

In some examples, a relationship between a first user and a second user may be based on common interests. As used herein, a “common” interest may be determined where a first user and a second user may have a same interest. For example, in an instance where a first user and a second user may both have an interest in “hiking”, the interest may be a common interest.

In some examples, as determined via the instructions 106, a relationship between a first user and a second user may be based on “similarity”. As used herein, a first user and second user may share “similar” interest(s) if the (first) interest of the first user and the (second) interest of the second user may have a sufficient degree of similarity. As will be discussed below in greater detail, the instructions 106 may utilize various methods to determine that a first interest and a second may be similar.

In some examples, to determine a similar interest between a first user and a second user, the instructions 106 may “traverse” a taxonomy (e.g., a tree-based structure) of a plurality of interests to determine if a first interest and a second interest may be similar. In particular, in an example where the taxonomy may be represented by a tree-based structure, the instructions 106 may look up common parent interests with respect to a first child interest (e.g., associated with a first user) and second child interest (e.g., associated with a second user).

In some examples, to look up common parent interests, the instructions 106 may look up an immediate parent interest. That is, in some examples where a first interest and a second interest may be included in an interest taxonomy, the instructions 106 may look up an immediate parent interest. In these examples, if an immediate parent interest may be same for both the first interest and the second interest, the instructions 106 may determine that the first interest and second interest may be similar.

In some examples, if a match may not be found in an immediate parent interest, the instructions 106 may look up one more “level” to determine if another (i.e., more general) parent interest may be same. So, in an example where a first parent interest may not be the same, the instructions 106 may determine if a second (i.e., next level up) parent interest may be same. In this manner, the instructions 106 may go up a predetermined number of levels (e.g., two levels, three levels, etc.) to determine a parent interest that may be same.

In one example, a first user may have a first interest in “John Smith” (i.e., a basketball player), which may be associated with the following (i.e., narrower to broader) parent interests: “popular basketball players”, “basketball league”, “basketball”, and “sports”. In this example, a second user may have a second interest in “Cleveland Nighthawks” (i.e., a basketball team), which may be associated with the following (i.e., narrower to broader) parent interests: “basketball league”, “basketball”, and “sports”. In this example, a third user may have a third interest in “women’s basketball league”, which may be associated with the following (i.e., narrower to broader) parent interests: “basketball” and “sports”. In this example, a fourth user may have a fourth interest in “bowling”, which may be associated with the following parent interest: “sports”.

So, in this example, the instructions 106 may determine that the first user and the second user may have a similar interest based on “basketball league”, based on a common parent interest determined by going up two levels. Also, the instructions 106 may determine that the second user and the third user may have a similar interest based on “basketball”, based on a common parent interest determined by going up two levels. Furthermore, the instructions 106 may determine that the third user and the fourth user may have a similar interest based on “basketball”, based on a common parent interest determined by going up three levels. However, if the instructions 106 limit determining of similar interests to determining a common parent interest by going up two or less levels, then the instructions 106 may determine that the first user and the second user may have a similar interest and the second user and the third user may have a similar interest. However, the instructions 106 may further determine that the third user and the fourth user (i.e., wherein the common parent interest requires going up three levels) may not have share a similar interest, as the common parent interest (i.e., basketball) may be too broad or generic to reliably represent a shared interest.

Accordingly, it should be appreciated that determining a similar interest via the instructions 106 may, in some instances, require a “balancing” of various considerations. Such considerations include granularity of interests, correlation of interests and generation of a sufficient and/or desired number of interests. In particular, in some instances, to determine a similar interest between a first user and a second user, the instructions 106 may be configured to consider a sufficient number of levels that a shared interest may be found, but not so many that the shared interest may be too generic.

In some examples, the instructions 107 may determine an arrangement of a plurality of users in relation to a first user. As used herein, an “arrangement” may include any gathering of a plurality of users according to any criteria. So, in some examples, the instructions 107 may utilize one or more common interests and/or similar interests to determine a relationship between a first user and a second user from amongst the plurality of users.

In some examples, the instructions 107 may generate indicia to indicate a relationship between a first user and a second user. In some examples, the indicia may be quantitative or numerical (e.g., a shared interest score), or may be qualitative (e.g., an interest-based categorization).

So, in some examples, the instructions 107 may analyze one or more common interests and/or similar interests shared by a first user and a second user (from amongst a plurality of users) to determine a shared interest score shared by the first user and the second user. Moreover, in some examples the instructions 107 may determine a shared interest score between the first user and each user from amongst the plurality of users to determine respective shared interest scores. It should be appreciated that to determine a shared interest score for the first user and the second user among a plurality of (other) users, various weighting methodologies may be utilized to account for various aspects of the determination.

In some examples, the instructions 107 may utilize determine a plurality of shared interest scores with respect to a first user and a plurality of (other) users to generate a queue (i.e., a ranking) of users. In some examples, the queue of users may be arranged according to a degree of similarity in the interests shared between the first user and each of the plurality of (other) users (i.e., an “interest-based queue”). Moreover, in some examples, the instructions 107 may utilize the interest-based queue to determine a number of users (e.g., ten users, twenty users, etc.) that exhibit a sufficient degree of similarity in shared interests.

In some examples, the instructions 108 may generate an engagement item associated with a first user a second user. In particular, in some examples, the instructions 108 may generate an engagement item between the first user and the second user in association with a common interest and/or a shared interest. As used herein, an “engagement item” may include any communication that may be transmitted to enable a first user and a second user to engage each other. Examples of engagement items that may be generated by the instructions 108 may include (among other things) conversation starters, “icebreakers” and prompts. In some examples, the engagements items that may be generated by the instructions 108 may take various forms, such as an electronic mail (i.e., email), a text (e.g., short message service (SMS)) message, etc. It should be appreciated that the engagement items generated via the instructions 108 may be implemented in various contexts, such as dating, social causes and groups.

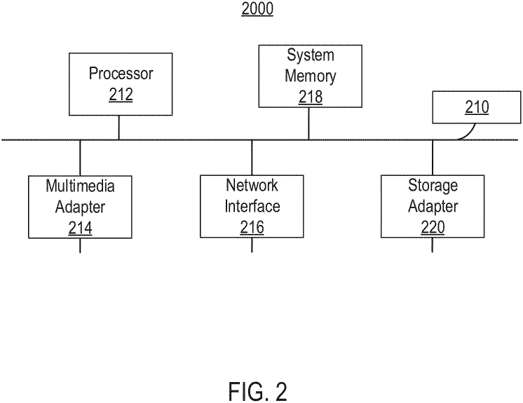

FIG. 2 illustrates a block diagram of a computer system for generating shared interests between a first user and a second user and utilizing the generated shared interests to facilitate communication between the first user and the second user. In some examples, the system 2000 may be associated the system 100 to perform the functions and features described herein. The system 2000 may include, among other things, an interconnect 210, a processor 212, a multimedia adapter 214, a network interface 216, a system memory 218, and a storage adapter 220.

The interconnect 210 may interconnect various subsystems, elements, and/or components of the external system 200. As shown, the interconnect 210 may be an abstraction that may represent any one or more separate physical buses, point-to-point connections, or both, connected by appropriate bridges, adapters, or controllers. In some examples, the interconnect 210 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect 210 may allow data communication between the processor 212 and system memory 218, which may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 212 may be the central processing unit (CPU) of the computing device and may control overall operation of the computing device. In some examples, the processor 212 may accomplish this by executing software or firmware stored in system memory 218 or other data via the storage adapter 220. The processor 212 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 214 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 216 may provide the computing device with an ability to communicate with a variety of remote devices over a network (e.g., network 400 of FIG. 1A) and may include, for example, an Ethernet adapter, a Fibre Channel adapter, and/or other wired- or wireless-enabled adapter. The network interface 216 may provide a direct or indirect connection from one network element to another, and facilitate communication and between various network elements.

The storage adapter 220 may connect to a standard computer-readable medium for storage and/or retrieval of information, such as a fixed disk drive (internal or external).

Many other devices, components, elements, or subsystems (not shown) may be connected in a similar manner to the interconnect 210 or via a network (e.g., network 400 of FIG. 1A). Conversely, all of the devices shown in FIG. 2 need not be present to practice the present disclosure. The devices and subsystems can be interconnected in different ways from that shown in FIG. 2. Code to implement the dynamic approaches for payment gateway selection and payment transaction processing of the present disclosure may be stored in computer-readable storage media such as one or more of system memory 218 or other storage. Code to implement the dynamic approaches for payment gateway selection and payment transaction processing of the present disclosure may also be received via one or more interfaces and stored in memory. The operating system provided on system 100 may be MS-DOS, MS-WINDOWS, OS/2, OS X, IOS, ANDROID, UNIX, Linux, or another operating system.

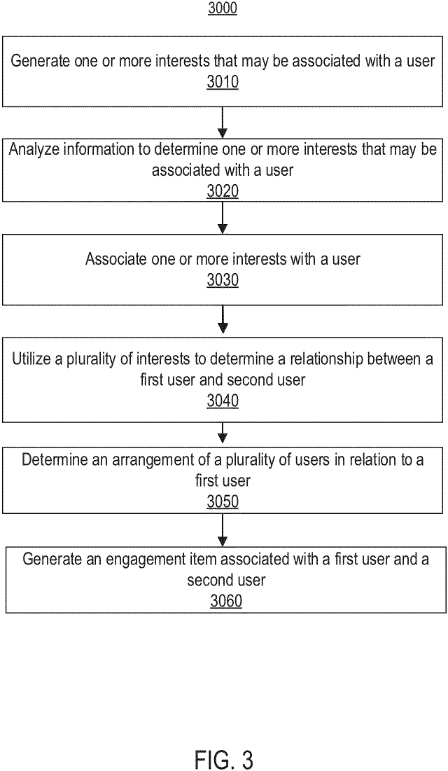

FIG. 3 illustrates a method 3000 for generating shared interests between a first user and a second user and utilizing the generated shared interests to facilitate communication between the first user and the second user, according to an example. The method 3000 is provided by way of example, as there may be a variety of ways to carry out the method described herein. Each block shown in FIG. 3 may further represent one or more processes, methods, or subroutines, and one or more of the blocks may include machine-readable instructions stored on a non-transitory computer-readable medium and executed by a processor or other type of processing circuit to perform one or more operations described herein.

Although the method 3000 is primarily described as being performed by system 100 as shown in FIGS. 1A-1B, the method 3000 may be executed or otherwise performed by other systems, or a combination of systems. It should be appreciated that, in some examples, to generate shared interests between a first user and a second user and utilize the generated shared interests to facilitate communication between the first user and the second user, as described above. It should also be appreciated that, in some examples, the method 3000 may be implemented in conjunction with a content platform (e.g., a social media platform) to generate and deliver content.

Reference is now made with respect to FIG. 3. At 3010, the processor 101 may generate one or more interests that may be associated with a user. In some examples, to generate one or more interests that may be associated with a user, the processor 101 may determine a relationship between a first interest and a second interest based on a degree of particularity. Also, in some examples, the processor 101 may generate a taxonomy (e.g., a tree-based structure) based on a plurality of interests. So, in some examples, the processor 101 may utilize one or more relationships between a plurality of interests to generate the taxonomy.

At 3020, the processor 101 may analyze information to utilize one or more interests that may be associated with a user. In some examples, to utilize one or more interests associated with a user, the processor 101 may analyze information associated with a user. In some examples, this may include minimization of data collection and retention policies, and purpose-limited data collection as well.

So, in some examples, the information analyzed by the processor 101 may be based on an aspect of an item (e.g., a content item) that a user may engage, while in other examples, the information analyzed by the processor 101 may be based on actions taken by a user (e.g., upon navigation to particular destinations or provide particular interactions). Also, in some examples, to utilize one or more interests of a user, the processor 101 may generate an interest score associated with the interest and the user, and may further generate a ranking of interests associated with a user as well.

At 3030, the processor 101 may associate one or more interests to a user. In addition, the processor 101 further may generate a user interest profile (UIP). In some examples, a user interest profile (UIP) may describe one or more interests that may be determined with a user. Also, in some examples, to associate one or more interests with a user, the processor 101 may enable a user to provide an interest, may enable a user to confirm an interest (e.g., that may be presented via a selectable user interface), or may enable, or may enable a user to search for interest.

At 3040, the processor 101 may utilize a plurality of interests to determine a relationship between a first user and a second user. For example, in some instances, the processor 101 may utilize one or more of one or more interests associated with a first user, one or more interests associated with a second user, and one or more relationships between a plurality of interests to determine a relationship between a first user and a second user.

So, in some examples, to determine a relationship between a first user and a second user, the processor 101 may locate (e.g., overlay) one or more interests of the first user and the one or more interests of the second user with respect to the one or more relationships between a plurality of interests. In some examples, a relationship between a first user and a second user may be based on common interests. In some examples, a relationship between a first user and a second user may be based on “similarity”. As used herein, a first user and second user may share “similar” interest(s) if the (first) interest of the first user and the (second) interest of the second user may have a sufficient degree of similarity.

In some examples, to determine a similar interest between a first user and a second user, the processor 101 may “traverse” a taxonomy (e.g., a tree-based structure) of a plurality of interests to determine if a first interest and a second interest may be similar. In particular, in an example where the taxonomy may be represented by a tree-based structure, the processor 101 may look up common parent interests with respect to a first child interest (e.g., associated with a first user) and second child interest (e.g., associated with a second user). In some examples, to look up common parent interests, the processor 101 may look up an immediate parent interest. In some examples, if a match may not be found in an immediate parent interest, the processor 101 may look up one more “level” to determine if another (i.e., more general) parent interest may be same.

At 3050, the processor 101 may determine an arrangement of a plurality of users in relation to a first user. In particular, in some examples, the processor 101 may utilize one or more common interests and/or similar interests to determine a relationship between a first user and a second user from amongst the plurality of users. Also, in some examples, the processor 101 may generate indicia (e.g., a shared interest score) to indicate a relationship between a first user and a second user. So, in some examples, the processor 101 may analyze one or more common interests and/or similar interests shared by a first user and a second user (from amongst a plurality of users) to determine a shared interest score shared by the first user and the second user. It should be appreciated that to determine a shared interest score for the first user and the second user among a plurality of (other) users, various weighting methodologies may be utilized to account for various aspects of the determination. In some examples, the processor 101 may utilize determine a plurality of shared interest scores with respect to a first user and a plurality of (other) users to generate a queue (i.e., a ranking) of users. In some examples, the queue of users may be arranged according to a degree of similarity in the interests shared between the first user and each of the plurality of (other) users (i.e., an “interest-based queue”).

At 3060, the processor 101 may generate an engagement item associated with a first user and a second user. In particular, in some examples, the processor 101 may generate an engagement item between the first user and the second user in association with a common interest and/or a similar interest.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

One of the most appealing and convenient forms of content is text content. Examples include user groups and user pages on content platforms. Users may particularly favor such content as it may enable them to discuss a wide variety of subject matter(s) with like-minded (i.e., similarly interested) users.

In some instances, a user participating in a particular user group or a particular user page may wish to generate a related user group or user page. For example, in one such instance, a member of a user group on a content platform entitled “Let’s all be politicians today” may wish to create a related group entitled “Let’s all be parents today.” However, it should be appreciated that, in some instances, recruiting users to the (new) related group may be inconvenient, as it may require more time and effort than a user may wish to expend.

Systems and methods described may provide for generation of user interactions based on text content using artificial intelligence (AI) techniques. As used herein, a “user interaction” may include any communication that may involve a plurality of users. Examples may include any communication between user groups (or “groups”) that may be found, for example, on a content platform (e.g., a social media platform). Additional examples may include any communication between a plurality of users in association with a content “page” on a content platform. So, in an example where a user interaction may be a user group on a content platform entitled “Let’s all be emo kids today,” the systems and methods may enable a user to create a related user group (i.e., a related user interaction) entitled “Let’s all be politicians today.”

In some examples, to generate a related user interaction, the systems and methods may identify an existing user interaction. In particular, in some examples, the systems and methods may analyze aspects of an existing user interaction to determine aspects that may be utilized to create a related user interaction.

In some examples, the systems and methods may determine a candidate user interaction that may be associated with an existing user interaction. As used herein, a “candidate user interaction” may include any communication that may involve a plurality of users based on any topic or subject matter that may (e.g., prospectively) determined to be a basis for a user interaction between a plurality of users. Examples of types of user interactions that may be candidate user interactions may include, but are not limited to, communications associated with user groups or user pages. In particular, in some examples, the systems and methods may determine one or more candidate user interactions that may be (among other things) suggested to a user that may be interested in creating a related user interaction.

In some examples, the systems and methods may facilitate creation of a related user interaction. As used herein, a “related user interaction” may be any user interaction that may be associated with an existing user interaction. In some examples, the related user interaction may also be referred to as a “spinoff” user interaction. So, in some examples, the systems and methods may provide a selectable button that user creator may select to create the related user interaction.

Furthermore, in some examples, the systems and methods may identify one or more user that may be interested in a related user interaction. In particular, in some examples, the systems and methods may analyze one or more aspects of a user to determine whether the user may be interested in the (newly-created) related user interaction. As discussed above, the information associated with the user may be gathered and implemented according to various policies (e.g., data policies, privacy policies, etc.).

The systems and methods described herein may be implemented in various contexts. In some examples, the systems and methods may enable a user member of a popular existing user interaction, such as a popular user group or user page, to “spin off” a similar user group or user page. In some examples, the systems and methods may utilize artificial intelligence (AI) based techniques to analyze aspects of the (e.g., trending) user interaction to facilitate the creation of related user interaction.

Accordingly, content creators may utilize the systems and methods described to efficiently generate content items that may be (more) conveniently consumed by users of a content platform (e.g., a social media platform). It should be appreciated that while the examples described herein may relate primarily to content generation, the systems and methods described may have numerous other applications as well.

In some examples and as described herein, a neural network (NN) that may be implemented may include one or more computing devices configured to implement one or more networked machine-learning (ML) algorithms to “learn” by progressively extracting higher-level information from input data. In some examples, the one or more networked machine-learning (ML) algorithms of a neural network (NN) may implement “deep learning”. A neural network (NN) implementing deep learning and artificial intelligence (AI) techniques may, in some examples, utilize one or more “layers” to dynamically transform input data into progressively more abstract and/or composite representations. These abstract and/or composite representations may be analyzed to determine hidden patterns and correlations and determine one or more relationships or association(s) within the input data. In addition, the one or more determined relationships or associations may be utilized to make predictions, such a likelihood that a user will be interested in a content item.

The systems and methods described herein may utilize various neural network (NN) technologies. Examples of neural network (NN) mechanisms that may be employed may include an artificial neural network (ANN), a sparse neural network (SNN), a convolutional neural network (CNN), and a recurrent neural network (RNN). Additional examples of neural network mechanisms that may be employed may also include a long/short term memory (LSTM), a gated repeated unit (GRU), a Hopfield network, a Boltzmann machine, a deep belief network and a generative adversarial network (GAN).

In addition to content item analysis and recommendation, neural networks (NN) may have a number of other applications as well. Exemplary applications may include text, image, audio and video recognition, natural language processing and machine learning. Additional examples may include recommendation systems, audio recognition (e.g., for virtual assistants), autonomous driving, social networks and bioinformatics.

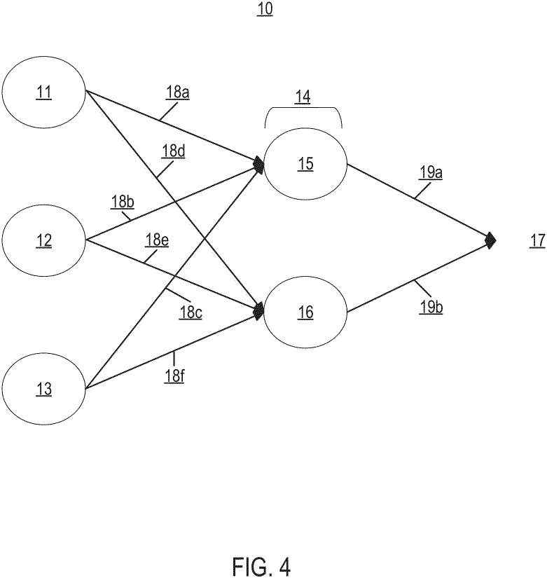

FIG. 4 illustrates a diagram of an implementation structure for a neural network (NN) implementing deep learning to generate and deliver related user interactions based on existing user interactions. In some examples, implementation of neural network 10 (hereinafter also referred to as “network 10”) may include organizing a structure of the network 10 and “training” the network 10.

In some examples, organizing the structure of the network 10 may include network elements including one or more inputs, one or more nodes and an output. In some examples, a structure of the network 10 may be defined to include a plurality of inputs 11, 12, 13, a layer 14 with a plurality of nodes 15, 16, and an output 17. In addition, in some examples, organizing the structure of the network 10 may include assigning one or more weights associated with the plurality of nodes 15, 16. In some examples, the network 10 may implement a first group of weights 18, including a first weight 18a between the input 11 and the node 15, a second weight 18b between the input 12 and the node 15, a third weight 18c between the input 13 and the node 15. In addition, the network 10 may implement a fourth weight 18d between the input 11 and the node 16, a fifth weight 18e between the input 12 and the node 16, and a sixth weight 18f between the input 13 and the node 16 as well. In addition, a second group of weights 19, including the first weight 19a between the node 15 and the output 17 and the second weight 19b between the node 16 and the output 17 may be implemented as well.

In some examples, “training” the network 10 may include utilization of one or more “training datasets” {(xᵢ, yᵢ)}, where i = 1 ... N for an N number of data pairs. In particular, as will be discussed below, the one or more training datasets {(xᵢ, yᵢ)} may be used to adjust weight values associated with the network 10.

Training of the network 10 may also include, in some examples, may also include implementation of forward propagation and backpropagation. Implementation of forward propagation and backpropagation may include enabling the network 10 to adjust aspects, such as weight values associated with nodes, by looking to past iterations and outputs. In some examples, a forward “sweep” through the network 10 to compute an output for each layer. At this point, in some examples, a difference (i.e., a “loss”) between an output of a final layer and a desired output may be “back-propagated” through previous layers by adjusting weight values associated with the nodes in order to minimize a difference between an estimated output from the network 10 (i.e., an “estimated output”) and an output the network 10 was meant to produce (i.e., a “ground truth”). In some examples, training of the network 10 may require numerous iterations, as the weights may be continually adjusted to minimize a difference between estimated output and an output the network 10 was meant to produce.

In some examples, once weights for the network 10 may be learned, the network 10 may be used make an “inference” and/or determine a prediction loss. In some examples, the network 10 may make an inference for a data instance, x*, which may not have been included in the training datasets {(xᵢ, yᵢ)}, to provide an output value y* (i.e., an inference) associated with the data instance x*. Furthermore, in some examples, a prediction loss indicating a predictive quality (i.e., accuracy) of the network 10 may be ascertained by determining a “loss” representing a difference between the estimated output value y* and an associated ground truth value.

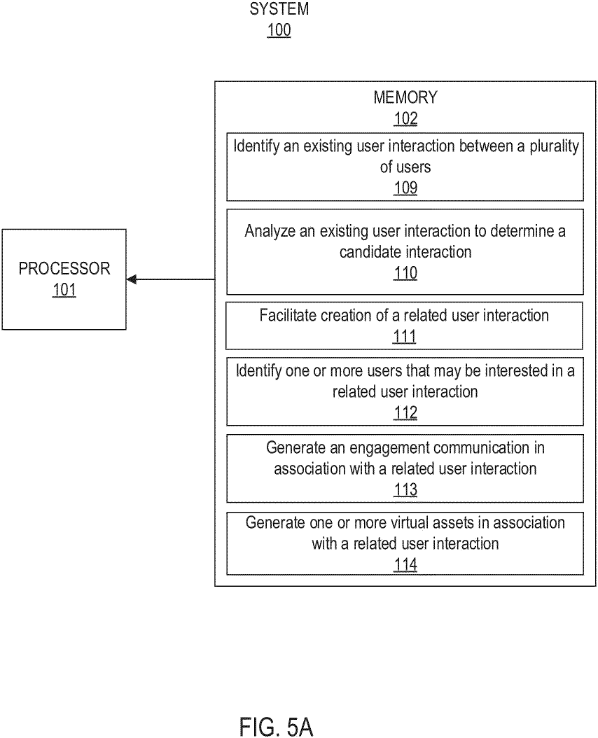

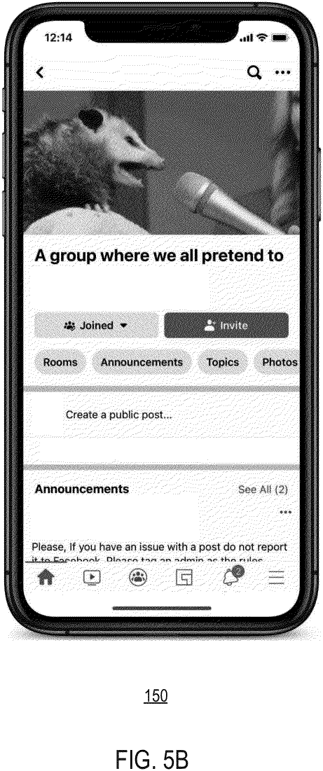

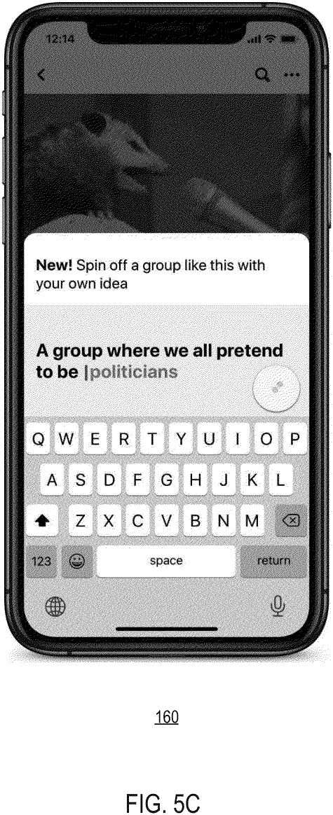

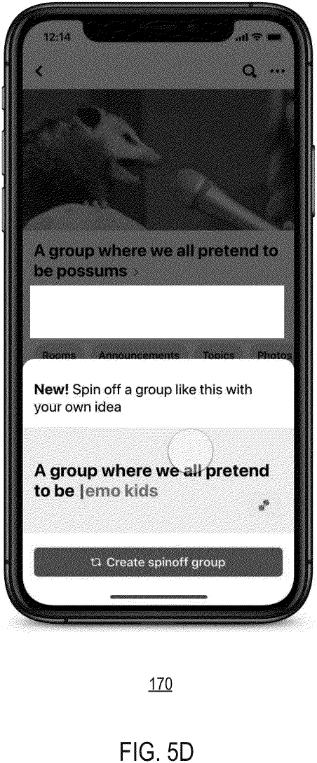

Reference is now made to FIGS. 5A-5D. FIGS. 5A-5D illustrate various aspects of a system environment, including a system, that may be implemented to use artificial intelligence (AI) techniques to generate and deliver related user interactions based on existing user interactions. FIG. 5A illustrates a block diagram of the system that may be implemented to utilize artificial intelligence (AI) techniques to generate and deliver related user interactions based on existing user interactions, according to an example.

In some examples, the memory 102 (e.g., as illustrated in FIG. 1B) may store instructions, which when executed by the processor 101 (e.g., as illustrated in FIG. 1B), may cause the processor to: identify an existing user interaction between a plurality of users; analyze an existing user interaction to determine a candidate user interaction; facilitate creation of a related user interaction; identify one or more users that may be interested in a related user interaction; generate an engagement communication in association with a related user interaction; and generate one or more virtual assets in association with a related user interaction.

In some examples, and as discussed further below, the instructions 109-114 on the memory 102 may be executed alone or in combination by the processor 101 to utilize artificial intelligence (AI) techniques to generate and deliver related user interactions based on existing user interactions. In some examples, the instructions 109-114 may be implemented in association with a content platform configured to provide content for users, while in other examples, the instructions109114 may be implemented as part of a stand-alone application.

Additionally, and as described above, although not depicted, it should be appreciated that to provide generation and delivery of content, instructions 109-114 may be configured to utilize various artificial intelligence (AI) and machine learning (ML) based tools. For instance, these artificial intelligence (AI) and machine learning (ML) based tools may be used to generate models that may include a neural network (e.g., a recurrent neural network (RNN)), generative adversarial network (GAN), a tree-based model, a Bayesian network, a support vector, clustering, a kernel method, a spline, a knowledge graph, or an ensemble of one or more of these and other techniques. It should also be appreciated that the system 100 may provide other types of machine learning (ML) approaches, such as reinforcement learning, feature learning, anomaly detection, etc.

In some examples, the instructions 109 may identify an existing user interaction between a plurality of users. In some examples, to identify an existing user interaction, the instructions 109 may associate an existing user interaction with, among other things, an interest, a topic and/or a theme. In one example, the existing user interaction may be a user group identified as “Los Angeles Cougars fans of San Francisco,” wherein the instructions 109 may associate the user group with a topic of “football.” In another example, the existing user interaction may be based on a user page dedicated to a theme of “Food with threatening auras,” wherein the instructions 109 may associate the user page with an interest of “food.” An example of a user interface element 150 related to a user group (i.e., an existing user interaction) named “A group where we all pretend to be possums” is shown in FIG. 5B.

In some examples, to identify an existing user interaction, the instructions 109 may evaluate various aspects of the existing user interaction. In some examples, an identification of the existing user interaction via the instructions 109 may be based on one or more criteria associated with the existing user interaction. In some examples, the one or more criteria implemented by the instructions 109 may be qualitative or quantitative.

Examples of qualitative criteria implemented by the instructions 109 may be criteria that may include analysis of content (i.e., subject matter) associated with the existing user interaction. In some examples, the instructions 109 may implement various tools, such as natural language processing (NLP), to analyze aspects associated with content of the existing user interaction. For example, in some instances, the instructions 109 may evaluate subject matter of content of the existing user interaction (e.g., “I love this group so much!”) to determine a level of engagement.

Examples of quantitative criteria implemented by the instructions 109 may be criteria based on metrics associated with the existing user interaction. Examples of these metrics may include “shares”, “likes” and comments associated with the existing user interaction. It should be appreciated that consideration of the quantitative metrics may also include various rates that may be associated with the metrics. Examples of these rates may include a rate at which users may be sharing content associated with the existing user interaction, a rate at which users (e.g., group members of a group) associated with existing user interaction may be changing (e.g., increasing), and a rate at which users may be contributing content (e.g., comments) to the existing user interaction.

In some examples, the instructions 109 may associate a “weight” with each of the one or more criteria associated with the existing user interaction. In particular, in some examples, the instructions 109 may associate a “weight” value to each of criteria to indicate a significance. In some examples, each weight associated with one or more criteria may be utilized to model various aspects associated with identifying the existing user interaction. For example, in some instances, a weight associated with number of comments associated with the existing user interaction may be weighted more than a weight associated with a date that the existing user interaction may have originated.

In some examples, the instructions 109 may determine an interest level in one or more existing user interactions. Furthermore, in some examples, the instructions 109 may sort the plurality of existing user interactions based on the one or more determined interest levels. In particular, in some examples, the instructions 109 may determine an existing user interaction that may be “trending”. As used herein, a user interaction may be “trending” if it may be of interest to a particular number of individuals at a particular period of time. In addition, the instructions 109 may determine that a first existing user interaction may be more likely to be “trending” than a second existing user interaction.

It should be appreciated that to identify the existing user interaction, the instructions 109 may incorporate various mathematical and modeling techniques, including one or more of machine learning (ML), artificial intelligence (AI), deep learning, and heuristics techniques. For instance, these AI-based machine learning (ML) tools may be used to generate models that may include a neural network, a generative adversarial network (GAN), a tree-based model, a Bayesian network, a support vector, clustering, a kernel method, a spline, a knowledge graph, or an ensemble of one or more of these and other techniques. It should be appreciated that the system 100 may provide other types of machine learning (ML) approaches as well, such as reinforcement learning, feature learning, anomaly detection, etc.

In some examples, to identify an existing user interaction, the instructions 109 may analyze one or more aspects of a user associated with the existing user interaction. In one example, the instructions 109 may analyze one or more aspects of a creator (also “originator” or “user creator”) of the existing user interaction. Examples of the types of information that may be analyzed in association with the user creator include personal characteristics (e.g., interests), browsing history and demographic information.

In some examples, the instructions 110 may analyze an existing user interaction to determine a candidate user interaction. In some examples, the instructions 110 may determine a candidate user interaction associated (e.g., thematically associated) with an existing user interaction. For example, in an instance where the existing user interaction may be a group conversation entitled (i.e., associated with) “Los Angeles Cougars fans of San Francisco,” the instructions 110 may determine that a candidate user interaction may be Los Angeles Cougars fans of Chicago.” Also, for example, in an instance where the existing user interaction (i.e., interest) may be associated with “Teenage Chess aficionados,” the instructions 110 may determine that a candidate user interaction may be “Teenage Poker aficionados.” Also, for example, in an instance where the existing user interaction may be a user page associated with may be “Food with threatening auras,” the instructions 110 may determine that a candidate user interaction may be “Bathrooms with threatening auras.”

In some examples, to determine a candidate user interaction, the instructions 110 may access a listing of previously-identified user activities. In particular, in some examples, the instructions 110 may access the listing of previously-identified user activities, wherein each of the previous-identified user activities may have one or more associations with one or more of other previously-identified user activities.

In some examples, the instructions 110 may utilize a listing of previously-identified user activities to determine that a user interaction based on a first interest may be associated with another user interaction based on a second (related) user interest. In one example, the instructions 110 may access the listing of previously-identified user activities to determine that “poker” as an interest (i.e., and that may be a basis for a user interaction) may be related to an “chess” as an interest. In this example, to determine a candidate user interaction, the instructions 110 may utilize the association to determine that where an existing user interaction may be a group named “Teenager Poker aficionados”, a (prospective) candidate user interaction may be “Teenage Chess aficionados”.

Furthermore, in some examples, the instructions 110 may utilize a recommendation algorithm to determine a candidate user interaction. In particular, in some examples, the instructions 110 may implement the recommendation algorithm to determine a candidate user interaction may be associated with an existing user interaction. In these examples, the recommendation algorithm implemented by the instructions 110 may analyze (among other things) associated metrics, user behavior(s), and historical patterns of one or more users. Moreover, in these examples, the recommendation algorithm implemented by the instructions 110 may generate preference information that may be used to determine the candidate user interaction as well.

It should be appreciated that to determine a candidate user interaction, the instructions 110 may be configured to incorporate various mathematical and modeling techniques, including one or more of machine learning (ML), artificial intelligence (AI), deep learning, and heuristics techniques. For instance, these AI-based machine learning (ML) tools may be used to generate models that may include a neural network, a generative adversarial network (GAN), a tree-based model, a Bayesian network, a support vector, clustering, a kernel method, a spline, a knowledge graph, or an ensemble of one or more of these and other techniques. It should be appreciated that the system 100 may provide other types of machine learning (ML) approaches as well, such as reinforcement learning, feature learning, anomaly detection, etc.

In some examples, the instructions 111 may facilitate creation of a related user interaction. In some examples, the related user interaction may be based on a candidate user interaction (e.g., as determined via the instructions 110), while in other examples, the related user interaction may be unassociated with any candidate user interaction.

In some examples, to enable creation of a related user interaction, the instructions 111 may provide recommendations for related groups to a user. So, in some examples, the instructions 111 may utilize a listing of previously-identified user activities (e.g., via the instructions 110), wherein the instructions 111 may access the listing of previously-identified user activities to “suggest” a related user interaction. Also, in some examples, to suggest a related user interaction, the instructions 111 may access one or more related user interactions that may be generated via one or more of machine learning (ML), artificial intelligence (AI), deep learning, and heuristics techniques (e.g., via the instructions 110) as well.

In some examples, to suggest a related user interaction associated with an existing user interaction, the instructions 111 may implement an “auto-fill” feature. In some examples, the auto-fill feature may provide one or more related user interactions as suggestions, wherein the one or more related user interactions may be presented to the user in a form associated with creation of the related user group. Accordingly, in some examples, the instructions 111 may implement an auto-fill feature to enable a user creator to “scroll” through the one or more (suggested) related user interactions, and may enable the user creator to select one (or more) of the related user interactions for creation. In one such example related to an existing user interaction “Food with threatening auras”, a user creator may, for example, select a button that may provide (e.g., scrollable) suggestions for related user interactions including “Caves with threatening auras” and “Bathrooms with threatening auras,” which the user creator may select from to create the related user interaction. An example of a user interface element 160 (e.g., as may be provided by the instructions 111) providing an auto-fill suggestion for a new group entitled “A group where we all pretend to be politicians” is shown in FIG. 5C.

In other examples, the instructions 111 may implement the auto-fill feature to “complete” the user’s typed characters (i.e., in an associated form) with suggestions of one or more related user interactions, which the user may select from to create a related user interaction. In one such example, related to an existing user interaction (e.g., user group) entitled “A group where we are all emo kids,” the instructions 111 may be configured to “complete” a user creator’s typed characters to suggest a related user interaction entitled “A group where we are all millennials.”

In some examples, to enable creation of a related user interaction, the instructions 111 may provide a selectable button in association with an existing user interaction. So, in an example where the existing user interaction may be a user group entitled “Bathrooms with threatening auras,” the instructions 111 may provide a selectable button that may enable a user (e.g., a user creator) to create a related user interaction named “Food with threatening auras”. In some examples, upon selection of the selectable button, the instructions 111 may provide a user interface element represented by a “form” that a user creator may fill in to create the related user interaction.

In some examples, to enable creation of a related user interaction, the instructions 111 may enable a user (e.g., a user creator) to set a title or name for the related user interaction. So, in some examples, the instructions 111 may enable a user to access a form associated with the related user interaction to be created, and may enable a user to enter a name or title for the related user interaction to be created. An example of a user interface element 170 (e.g., as may be provided by the instructions 111) providing a selectable button to enable creation of a new group entitled “A group where we all pretend to be emo kids” is shown in FIG. 5D.

In some examples, the instructions 112 may identify one or more users that may be interested in a related user interaction. In particular, in some examples, the instructions 113 may identify one or more users based on a likelihood that each of the one or more users may be interested in the related user interaction.

In some examples, to identify one or more users that may be interested in a related user interaction, the instructions 112 may access various user information. As used herein, the “user information” may include any information that may be associated with a user. Examples may include demographic information (e.g., age, gender, etc.), preference information (e.g., viewing history, purchase history, etc.), and locational information associated with the user. Other examples may be content-related, such as browsing histories, content categories and preferences, and particular content items associated with the user (e.g., video, images posted on a content platform, etc.).

In some examples, to identify one or more users that may be interested in a related user interaction, the instructions 112 may utilize user information to determine one or more commonalities between a first user and a second user. As discussed above, the information associated with the user may be gathered and implemented according to various policies (e.g., data policies, privacy policies, etc.).

In one example, if a first user (e.g., a user creator) interested in the related user interaction may be interested in a particular content type, the instructions 113 may determine that a second user also interested in the particular content type may be interested in the related user interaction as well. In some examples, to identify one or more users that may be interested in a related user interaction, the instructions 112 may determine one or more demographic criteria (e.g., as provided an opt-in policy). In particular, in some examples, the instructions 112 may determine one or more demographic criteria to utilize with respect to determining one or more users that may be associated with the related user interaction. Also, in some examples, to identify one or more users that may be interested in a related user interaction, the instructions 112 may determine the one or more demographic criteria that may facilitate various aspects of growth. In some examples, the various aspects of growth may include users (i.e., numbers of users), engagement (i.e., growth and retention of interaction) and/or transactions (e.g., revenue). So, in one example, to facilitate user growth in association with a related user interaction (e.g., a group) entitled “Pearl Harbor memorabilia collectors,” the instructions 112 may prioritize demographic criteria such as location (e.g., users located in the United States) and age (e.g., born between the years 1925 and 1975).

In some examples, to identify one or more users that may be interested in a related user interaction, the instructions 112 may determine one or more users for a related user interaction based on users associated with an existing user interaction. So, in an example where the existing user interaction may be a group entitled “Manga lovers of New York” and having one thousand user members (or followers), the instructions 112 may determine that some or all of the one thousand user members should be engaged (e.g., invited to join) regarding a related user interaction entitled “Anime lovers of New York.”

In some examples, to identify one or more users that may be interested in a related user interaction, the instructions 112 may identify one or more users associated with a user creator of the related user interaction. In particular, in some examples, the instructions 112 may determine that one or more followers of a profile page or account on a content platform associated with the user creator may be likely to be interested in the related user interaction. So, in an example where the user creator may be a college student that may create a user page associated with the University of North Haven (i.e., a related user interaction), the instructions 112 may determine that followers of the user creator’s profile page may be engaged to participate in the (newly-created) user page.

In some examples, the instructions 112 may identify one or more users that may be interested in a related user interaction upon creation of the related user interaction (e.g., via the instructions 111). However, it should be appreciated that in other examples, the instructions 112 may identify the one or more users that may be interested in a related user interaction prior to creation of the related user interaction (e.g., as part of determining one or more candidate user interactions via the instructions 110).

In some examples, the instructions 113 may generate an engagement communication that may be directed to one or more users that may be likely to be interested in engaging (e.g., participating) in the related user interaction. In some examples, the engagement communication generated by the instructions 113 may be an engagement communication that may invite the one or more users to engage in the related user interaction.

In some examples, the instructions 113 may enable a user (e.g., a user creator) to generate an engagement communication. For example, in some instances, the instructions 113 may enable a user, such as a user creator, to direct the engagement communication to users associated with an existing user interaction. So, in one example where the existing user interaction may be a user group for “Food with threatening auras,” the instructions 113 may enable a user creator of a new group for “Caves with threatening auras” (i.e., the related user interaction”) to send an engagement communication to one or more users associated with “Food with threatening auras.”

In some examples, the instructions 114 may generate one or more virtual assets in association with a related user interaction. As used herein, a “virtual asset” may be comprised of one or more elements of digital data. Examples of the types of digital data that may be utilized to generate a virtual asset include, but are not limited to, digital images, digital videos, digital audio, digital text, digital objects (e.g., bitmaps) and augmented reality (AR), mixed reality (MR) and virtual reality (VR) objects. So, in one example, upon creation of the related user interaction (e.g., a user group entitled “Bathrooms with threatening auras”), the instructions 114 may generate a bitmap image (i.e., a “GIF”) that may be utilized by users associate with the related user interaction. It should be appreciated that to generate the or more virtual assets, the instructions 108 may incorporate various mathematical and modeling techniques, including one or more of machine learning (ML), artificial intelligence (AI), deep learning, and heuristics techniques.

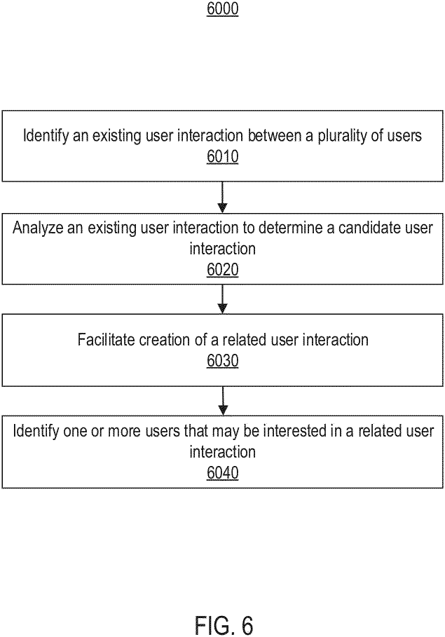

FIG. 6 illustrates a method for using artificial intelligence (AI) techniques to generate audio and video content based on text content. The method 6000 is provided by way of example, as there may be a variety of ways to carry out the method described herein. Each block shown in FIG. 6 may further represent one or more processes, methods, or subroutines, and one or more of the blocks may include machine-readable instructions stored on a non-transitory computer-readable medium and executed by a processor or other type of processing circuit to perform one or more operations described herein.

Although the method 6000 is primarily described as being performed by system 100 as shown in FIGS. 1A-1B, the method 6000 may be executed or otherwise performed by other systems, or a combination of systems. It should be appreciated that, in some examples, to generate audio and video content based on text content, the method 6000 may be configured to incorporate artificial intelligence (AI) or deep learning techniques, as described above. It should also be appreciated that, in some examples, the method 6000 may be implemented in conjunction with a content platform (e.g., a social media platform) to generate and deliver content.

Reference is now made with respect to FIG. 6. At 6010, the processor 101 may identify an existing user interaction between a plurality of users. In some examples, to identify an existing user interaction, the processor 101 may associate an existing user interaction with, among other things, an interest, a topic and/or a theme. In some examples, to identify an existing user interaction, the processor 101 may evaluate various aspects of the existing user interaction including qualitative or quantitative criteria.

At 6020, the processor 101 may analyze an existing user interaction to determine a candidate user interaction. In particular, in some examples, the processor 101 may utilize a listing of previously-identified user activities to determine that a user interaction based on a first interest may be associated with another user interaction based on a second (related) user interest. It should be appreciated that to determine a candidate user interaction, the processor 101 may be configured to incorporate various mathematical and modeling techniques, including one or more of machine learning (ML), artificial intelligence (AI), deep learning, and heuristics techniques.

At 6030, the processor 101 may facilitate creation of a related user interaction. In particular, in some examples, to enable creation of a related user interaction, the processor 101 may provide a selectable button in association with an existing user interaction. Also, in some examples, to enable creation of a related user interaction, the processor 101 may enable a user (e.g., a user creator) to set a title or name for the related user interaction.

At 6040, the processor 101 may identify one or more users that may be interested in a related user interaction. So, in some examples, to identify one or more users that may be interested in a related user interaction, the processor 101 may access and analyze various user information. As discussed above, the information associated with the user may be gathered and implemented according to various policies (e.g., data policies, privacy policies, etc.). In addition, in some examples, to identify one or more users that may be interested in a related user interaction, the processor 101 may determine one or more users for a related user interaction based on users associated with an existing user interaction.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

It should be noted that the functionality described herein may be subject to one or more privacy policies, described below, enforced by the system 100, the external system 200, and the user devices 300 that may bar use of images for concept detection, recommendation, generation, and analysis.

In particular examples, one or more objects of a computing system may be associated with one or more privacy settings. The one or more objects may be stored on or otherwise associated with any suitable computing system or application, such as, for example, the system 100, the external system 200, and the user devices 300, a social-networking application, a messaging application, a photo-sharing application, or any other suitable computing system or application. Although the examples discussed herein may be in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” of users or other entities that should not be allowed to access certain information associated with the object. In particular examples, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the system 100, the external system 200, and the user devices 300, or shared with other systems. Although this disclosure describes using particular privacy settings in a particular manner, this disclosure contemplates using any suitable privacy settings in any suitable manner.

In particular examples, the system 100, the external system 200, and the user devices 300 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the system 100, the external system 200, and the user devices 300 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user’s current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different objects of the same type associated with a user may have different privacy settings. Different types of objects associated with a user may have different types of privacy settings. As an example and not by way of limitation, a first user may specify that the first user’s status updates are public, but any images shared by the first user are visible only to the first user’s friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user’s employer. In particular examples, different privacy settings may be provided for different user groups or user demographics. As an example and not by way of limitation, a first user may specify that other users who attend the same university as the first user may view the first user’s pictures, but that other users who are family members of the first user may not view those same pictures.

In particular examples, the system 100, the external system 200, and the user devices 300 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular examples, privacy settings may allow a first user to specify (e.g., by opting out, by not opting in) whether the system 100, the external system 200, and the user devices 300 may receive, collect, log, or store particular objects or information associated with the user for any purpose. In particular examples, privacy settings may allow the first user to specify whether particular applications or processes may access, store, or use particular objects or information associated with the user. The privacy settings may allow the first user to opt in or opt out of having objects or information accessed, stored, or used by specific applications or processes. The system 100, the external system 200, and the user devices 300 may access such information in order to provide a particular function or service to the first user, without the system 100, the external system 200, and the user devices 300 having access to that information for any other purposes. Before accessing, storing, or using such objects or information, the system 100, the external system 200, and the user devices 300 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the system 100, the external system 200, and the user devices 300.

In particular examples, a user may specify whether particular types of objects or information associated with the first user may be accessed, stored, or used by the system 100, the external system 200, and the user devices 300. As an example and not by way of limitation, the first user may specify that images sent by the first user through the system 100, the external system 200, and the user devices 300 may not be stored by the system 100, the external system 200, and the user devices 300. As another example and not by way of limitation, a first user may specify that messages sent from the first user to a particular second user may not be stored by the system 100, the external system 200, and the user devices 300. As yet another example and not by way of limitation, a first user may specify that all objects sent via a particular application may be saved by the system 100, the external system 200, and the user devices 300.

In particular examples, privacy settings may allow a first user to specify whether particular objects or information associated with the first user may be accessed from the system 100, the external system 200, and the user devices 300. The privacy settings may allow the first user to opt in or opt out of having objects or information accessed from a particular device (e.g., the phone book on a user’s smart phone), from a particular application (e.g., a messaging app), or from a particular system (e.g., an email server). The system 100, the external system 200, and the user devices 300 may provide default privacy settings with respect to each device, system, or application, and/or the first user may be prompted to specify a particular privacy setting for each context. As an example and not by way of limitation, the first user may utilize a location-services feature of the system 100, the external system 200, and the user devices 300 to provide recommendations for restaurants or other places in proximity to the user. The first user’s default privacy settings may specify that the system 100, the external system 200, and the user devices 300 may use location information provided from one of the user devices 300 of the first user to provide the location-based services, but that the system 100, the external system 200, and the user devices 300 may not store the location information of the first user or provide it to any external system. The first user may then update the privacy settings to allow location information to be used by a third-party image-sharing application in order to geo-tag photos.

In particular examples, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. The system 100, the external system 200, and the user devices 300 may predict or determine a mood, emotion, or sentiment associated with a user based on, for example, inputs provided by the user and interactions with particular objects, such as pages or content viewed by the user, posts or other content uploaded by the user, and interactions with other content of the online social network. In particular examples, the system 100, the external system 200, and the user devices 300 may use a user’s previous activities and calculated moods, emotions, or sentiments to determine a present mood, emotion, or sentiment. A user who wishes to enable this functionality may indicate in their privacy settings that they opt in to the system 100, the external system 200, and the user devices 300 receiving the inputs necessary to determine the mood, emotion, or sentiment. As an example and not by way of limitation, the system 100, the external system 200, and the user devices 300 may determine that a default privacy setting is to not receive any information necessary for determining mood, emotion, or sentiment until there is an express indication from a user that the system 100, the external system 200, and the user devices 300 may do so. By contrast, if a user does not opt in to the system 100, the external system 200, and the user devices 300 receiving these inputs (or affirmatively opts out of the system 100, the external system 200, and the user devices 300 receiving these inputs), the system 100, the external system 200, and the user devices 300 may be prevented from receiving, collecting, logging, or storing these inputs or any information associated with these inputs. In particular examples, the system 100, the external system 200, and the user devices 300 may use the predicted mood, emotion, or sentiment to provide recommendations or advertisements to the user. In particular examples, if a user desires to make use of this function for specific purposes or applications, additional privacy settings may be specified by the user to opt in to using the mood, emotion, or sentiment information for the specific purposes or applications. As an example and not by way of limitation, the system 100, the external system 200, and the user devices 300 may use the user’s mood, emotion, or sentiment to provide newsfeed items, pages, friends, or advertisements to a user. The user may specify in their privacy settings that the system 100, the external system 200, and the user devices 300 may determine the user’s mood, emotion, or sentiment. The user may then be asked to provide additional privacy settings to indicate the purposes for which the user’s mood, emotion, or sentiment may be used. The user may indicate that the system 100, the external system 200, and the user devices 300 may use his or her mood, emotion, or sentiment to provide newsfeed content and recommend pages, but not for recommending friends or advertisements. The system 100, the external system 200, and the user devices 300 may then only provide newsfeed content or pages based on user mood, emotion, or sentiment, and may not use that information for any other purpose, even if not expressly prohibited by the privacy settings.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user’s friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the system 100, the external system 200, and the user devices 300 may be restricted in its access, storage, or use of the objects or information. The system 100, the external system 200, and the user devices 300 may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the system 100, the external system 200, and the user devices 300 may temporarily store the message in a content data store until the second user has viewed or downloaded the message, at which point the system 100, the external system 200, and the user devices 300 may delete the message from the data store. As another example and not by way of limitation, continuing with the prior example, the message may be stored for a specified period of time (e.g., 2 weeks), after which point the system 100, the external system 200, and the user devices 300 may delete the message from the content data store.

In particular examples, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular examples, the system 100, the external system 200, and the user devices 300 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the system 100, the external system 200, and the user devices 300. The user’s privacy settings may specify that such information may be used only for particular processes, such as authentication, and further specify that such information may not be shared with any external system or used for other processes or applications associated with the system 100, the external system 200, and the user devices 300. As another example and not by way of limitation, the system 100, the external system 200, and the user devices 300 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user’s privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the system 100, the external system 200, and the user devices 300. As another example and not by way of limitation, the system 100, the external system 200, and the user devices 300 may provide a functionality for a user to provide a reference image (e.g., a facial profile, a retinal scan) to the online social network. The online social network may compare the reference image against a later-received image input (e.g., to authenticate the user, to tag the user in photos). The user’s privacy setting may specify that such voice recording may be used only for a limited purpose (e.g., authentication, tagging the user in photos), and further specify that such voice recording may not be shared with any external system or used by other processes or applications associated with the system 100, the external system 200, and the user devices 300.

In particular examples, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The system 100, the external system 200, and the user devices 300 may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the system 100, the external system 200, and the user devices 300 may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the system 100, the external system 200, and the user devices 300 may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the system 100, the external system 200, and the user devices 300 may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user’s default privacy settings may indicate that a person’s relationship status is visible to all users (e.g., “public”). However, if the user changes his or her relationship status, the system 100, the external system 200, and the user devices 300 may determine that such action may be sensitive and may prompt the user to confirm that his or her relationship status should remain public before proceeding. As another example and not by way of limitation, a user’s privacy settings may specify that the user’s posts are visible only to friends of the user. However, if the user changes the privacy setting for his or her posts to being public, the system 100, the external system 200, and the user devices 300 may prompt the user with a reminder of the user’s current privacy settings of posts being visible only to friends, and a warning that this change will make all of the user’s past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the system 100, the external system 200, and the user devices 300 may send a reminder to the user to confirm his or her privacy settings every six months or after every ten photo posts. In particular examples, privacy settings may also allow users to control access to the objects or information on a per-request basis. As an example and not by way of limitation, the system 100, the external system 200, and the user devices 300 may notify the user whenever an external system attempts to access information associated with the user, and require the user to provide verification that access should be allowed before proceeding.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims-and their equivalents-in which all terms are meant in their broadest reasonable sense unless otherwise indicated.

1. A system, comprising:
a processor;
a memory storing instructions, which when executed by the processor, cause the processor to:
utilize one or more interests associated with user activity;
generate a taxonomy based on the one or more interests associated with the user activity;
associate the one or more interests associated with the user activity with a first user; and
determine a relationship between the first user and a second user utilizing the one or more interests associated with the user activity.

2. The system of claim 1, wherein the instructions when executed by the processor further cause the processor to determine an arrangement of a plurality of other users in relation to the first user.

3. The system of claim 1, wherein the instructions when executed by the processor further cause the processor to generate an engagement item associated with the first user and the second user.

4. The system of claim 1, wherein the taxonomy based on the one or more interests associated with the user activity implements a tree-based structure.

5. The system of claim 1, wherein the instructions when executed by the processor further cause the processor to generate a ranking of interests associated with the first user and a ranking of interests associated with the second user.

6. The system of claim 1, wherein the instructions when executed by the processor further cause the processor to determine a relationship between the first user and the second user.

7. The system of claim 1, wherein the instructions when executed by the processor further cause the processor to determine a shared interest score shared by the first user and the second user.

8. The system of claim 7, wherein the instructions when executed by the processor further cause the processor to determine a plurality of shared interest scores, the plurality of shared interest scores including the shared interest score shared by the first user and the second user.

9. A method of generating and providing organization-based spaces for a virtual community of users, comprising:
determining one or more interests associated with user activity;
generating a taxonomy based on the one or more interests associated with the user activity;
associating the one or more interests associated with the user activity with a first user; and
determining a relationship between the first user and a second user utilizing the one or more interests associated with the user activity.

10. The method of claim 9, further comprising determining an arrangement of a plurality of other users in relation to the first user.

11. The method of claim 9, further comprising generating an engagement item associated with the first user and the second user.

12. The method of claim 9, wherein the taxonomy based on the one or more interests associated with the user activity implements a tree-based structure.

13. The method of claim 9, further comprising generating a ranking of interests associated with the first user and a ranking of interests associated with the second user.

14. The method of claim 9, further comprising determining a relationship between the first user and the second user.

15. The method of claim 9, further comprising determining a shared interest score shared by the first user and the second user.

16. The method of claim 15, further comprising determining a plurality of shared interest scores, the plurality of shared interest scores comprising the shared interest score shared by the first user and the second user.

17. A non-transitory computer-readable storage medium having an executable stored thereon, which when executed instructs a processor to:
identify an existing user interaction between a plurality of users;
analyze the existing user interaction to determine a candidate user interaction;
facilitate creation of a related user interaction based on the existing user interaction and the candidate user interaction; and
identify one or more users interested in the related user interaction.

18. The non-transitory computer-readable storage medium of claim 17, wherein the instructions when executed by the processor further cause the processor to generate an engagement communication in association with the related user interaction.

19. The non-transitory computer-readable storage medium of claim 17, wherein the instructions when executed by the processor further cause the processor to generate one or more virtual assets associated with the related user interaction.

20. The non-transitory computer-readable storage medium of claim 17, wherein to analyze the existing user interaction to determine a candidate user interaction, the instructions when executed by the processor further cause the processor to access a listing of previously-identified user activities.
